(19) United States
(12) Patent Application Publication
(10) Pub. No.: US 2003/0077948 A1
(43) Pub. Date: Apr. 24, 2003

(54) Plug-and-socket device

(76) Inventors: Wolfgang Rehmann, Asperg (DE); Gerhard Hueftle, Aspach (DE); Bernd Kuenzl, Schwieberdingen (DE)

Correspondence Address: KENYON & KENYON, ONE BROADWAY, NEW YORK, NY, 10004, US

(21) Appl. No.: 10/275,216

(22) PCT Filed: Mar. 1, 2002
(86) PCT No.: PCT/DE02/00744

(30) Foreign Application Priority Data
Mar. 3, 2001 (DE) 101 10 343.3

(51) Int. Cl. H01R 13/502

(52) U.S. Cl. 439/701

(57) ABSTRACT

A plug device (1) according to the present invention has a spring, which is integrated on an aggregate plug (3) and contacts an undercut (35) of a receiving part (5) and therefore secures the aggregate plug (3) on the receiving part (5). This constitutes a simple and cost-effective assembly of aggregate plug (3) and receiving part (5).

### BACKGROUND INFORMATION

The present invention relates to a plug device according to the species of claim 1.

It is known to use springs for securing an aggregate plug on a receiving part. In this context, the disadvantage exists that the spring can detach and the fastening function no longer be assured.

### ADVANTAGES OF THE INVENTION

In contrast, the plug device according to the present invention having the characterizing features of claim 1 has the advantage that a simple and therefore cost-effective assembly of aggregate plug on a receiving part is possible in a simple manner. The spring, functioning in this context for fastening purposes, is integrated in the aggregate plug and therefore cannot detach itself.

As a result of the measures indicated in the dependent claims, advantageous refinements and improvements of the plug device cited in claim 1 are possible.

It is advantageous if a wire spring is used for the spring, because it is simple and cost-effective.

It is also advantageous if the spring surrounds the aggregate plug in the radial circumferential direction at least half way, thus assuring that the spring is effectively integrated in the aggregate plug.

If at least one end of the spring is contacting one chamfer of the aggregate plug, then the spring can bend in response to the aggregate plug being slid onto a receiving part, without the spring being able to detach from the aggregate plug.

In this assembly process, it is advantageous if the spring only bends in the radial direction.

### DRAWING

An exemplary embodiment of the present invention is depicted in simplified form in the drawing and is discussed in greater detail in the description below.

The following are the contents:

FIG. 1a depicts a plug device according to the present invention in the non-assembled state.

FIG. 1B depicts a cutaway view along the line I-I of FIG. 2.

FIG. 2 depicts a plug device according to the present invention in the assembled state.

### DESCRIPTION OF THE EXEMPLARY EMBODIMENT

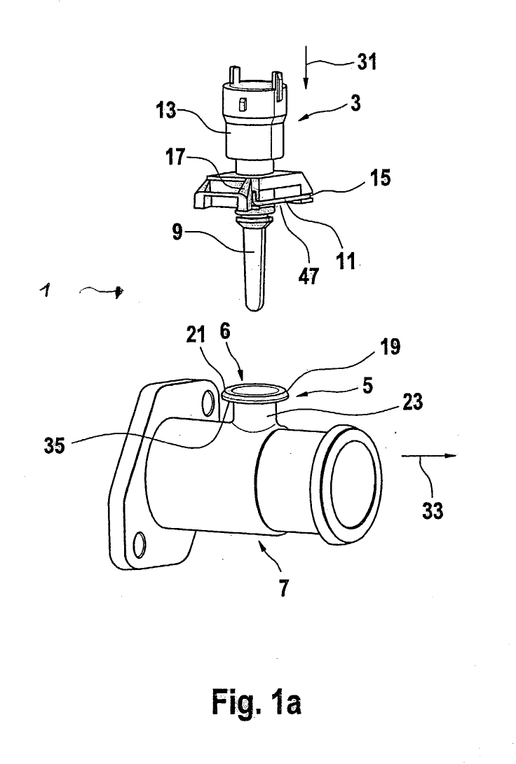

FIG. 1a depicts a plug device 1 according to the present invention, made up, in the non-assembled state, of an aggregate plug 3 and a receiving part 5.

Receiving part 5 is, for example, a tube end 23 having a projecting part 21 on its one free axial end. Tube end 23 is arranged on a component part 7, which is, for example, a supply line 7 or a reservoir 7. Through an opening 6, tube end 23 is connected to supply line 7 or reservoir 7.

Aggregate plug 3 has a plug connector 13 having electrical plug contacts (not depicted) and a sensor, for example, a temperature sensor 9. However, other sensors such as a volume measuring device can also be used. Integrated on aggregate plug 3 is a spring 11, for example, a wire spring 11.

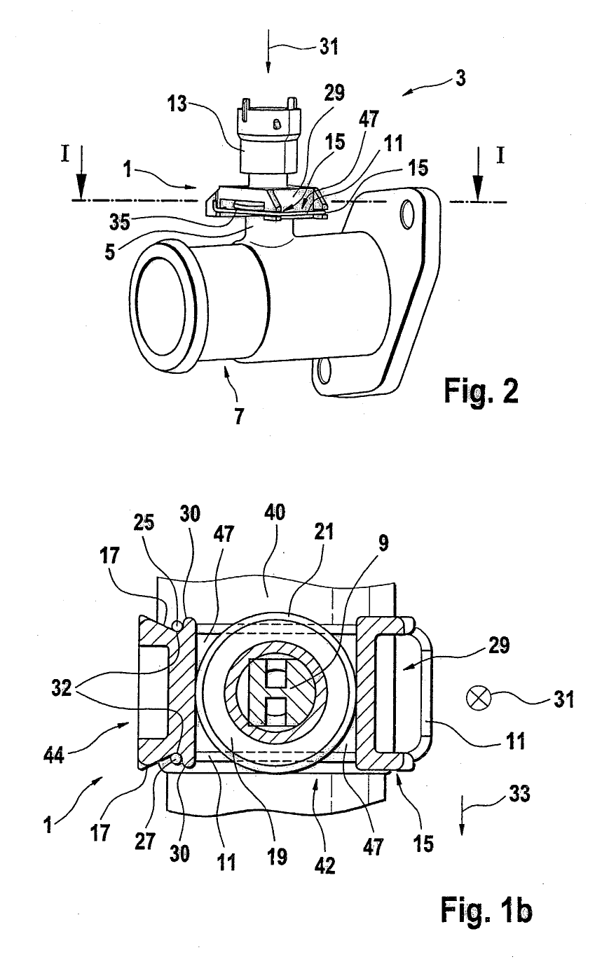

FIG. 1b depicts a radial cutout along line I-I of FIG. 2.

In this radial cross-section, aggregate plug 3 has, for example, a rectangular shape. Spring 11 surrounds aggregate plug 3 at least half way; in this example, spring 11 encompasses three lateral surfaces of aggregate plug 3. On a first lateral surface 29 of aggregate plug 3, spring 11 is at least partially arranged in a groove 15, so that it is secured in axial direction 31. On second lateral surface 40 and third lateral surface 42 of aggregate plug 3, bordering first lateral surface 29, spring 11 is at least partially free, so as then, at its first end 25, bent in axial direction 31 and, for example, also at its second end 27, bent in the axial direction, to contact a support surface 30, in each case, on an inclined surface or a chamfer 17, and in the direction of first lateral surface 29. Chamfer 17 together with support surface 30 forms an indentation 32, in which ends 25, 27 rest and from which inclined surfaces 17 run, such that the distance between them increases. Ends 25, 27 of wire spring 11 are bent, for example, at a 90 degree angle in an axial direction 31 either downwards or upwards (Figure la), and they are locked into place in indentation 32. In this context, groove 15 also runs in lateral surfaces 40, 42 up to indentation 32 and guides spring 11 there.

If aggregate plug 3 is slid onto receiving part 5 in axial direction 31, spring 11 comes into contact, for example, with a chamfer 19 (FIG. 1a) of projecting part 21, that widens in the plug-in direction, and, in response to aggregate plug 3 being further slid into receiving part 5, the spring is guided by the chamfer and is thus bent in radial direction 33. In this bending process, first end 25 and second end 27 of spring 11 are still in contact with support surfaces 30, although as a result of the bending they have somewhat been displaced towards the outside from their resting position in accordance with FIG. 1a, 1b. Projecting part 21, adjacent to chamfer 19, has an undercut 35, which causes spring 11 once again to snap back into position in accordance with FIG. 1b, and therefore to be contacted below projecting part 21, viewed in the axial direction 31, and the spring thus secures aggregate plug 3 in receiving part 5 in its end position. Aggregate plug 3 on lateral surfaces 40, 42 has a free space 47, in which projecting part 21 of receiving part 5 is partially arranged, in the assembled state (FIG. 2).

FIG. 2 depicts a plug device 1 according to the present invention in the assembled state. In this context, projecting part 21 is arranged in free space 47. Spring 11 contacts undercut 35 and prevents aggregate plug 3 from being inadvertently removed from receiving part 5. Spring 11 is exposed on first lateral surface 29 at least partially and can be shifted toward first lateral surface 29 in this area through an appropriate pressure being applied on spring 11, so that spring 11 glides on inclined surfaces 17 and extends beyond undercut 35 in the radial direction, thus making it possible to remove aggregate plug 3 from receiving part 5.

Groove 15 and the contact of spring 11 at indentation 32 make it impossible to detach the spring inadvertently.

What is claimed is:

1. A plug device (1), especially for a sensor, having an aggregate plug (3), and having a receiving part (5), into which the aggregate plug (3) can be reversibly inserted at least partially, a spring (11) being positioned on the aggregate plug (3), the spring (11) being bendable, such that it can be inserted into the receiving part (5) and then contacts an undercut (35) on the receiving part (5), and thus securing aggregate plug (3) to the receiving part (5).

2. The plug device as recited in claim 1, wherein the spring (11) is a wire spring.

3. The plug device as recited in claim 1, wherein at least one end (25, 27) of the spring (11) contacts a support surface (30) of the aggregate plug (3).

4. The plug device as recited in claim 1 or 3, wherein the spring (11) surrounds the aggregate plug (3) in the circumferential direction at least half way.

5. The plug device as recited in claim 1, wherein the spring (11), in response to the aggregate plug (3) being slid over receiving part (5), bends open almost exclusively in the radial direction (33).

6. The plug device as recited in claim 1, wherein the spring (11) is situated at least partially in a groove (15).
